(19) United States
(12) Patent Application Publication
(10) Pub. No.: US 2011/0248814 A1
(43) Pub. Date: Oct. 13, 2011

(54) Shielded-type inductor

(76) Inventors: Bor-Shiun Lee, Yangmei (TW); Chou-Mo Wang, Yangmei (TW)

(21) Appl. No.: 11/892,952

(22) Filed: Aug. 28, 2007

(51) Int. Cl. H01F 27/36

(52) U.S. Cl. 336/84 R

(57) ABSTRACT

An inexpensive shielded-type inductor is disclosed to include a first powder compact member, a coil embedded in the first powder compact member with the bottom side of the coil body thereof kept in flush with the bottom side of the first powder compact member and two metal terminals thereof extending from the two opposite ends of the coil body to the outside of the first powder compact member, and a second powder compact member bonded to the bottom side of the first powder compact member to determine the inductance value of the inductor subject to the thickness of the second powder compact member and to protect the inductor against external environmental factors.

### BACKGROUND OF THE INVENTION

1. Field of the Invention

The present invention relates to inductors and more particularly, to a shielded-type inductor, which is inexpensive to manufacture and free from interference of external environmental factors and, allows fine adjustment of the inductance value by means of controlling the thickness of the second powder compact member thereof.

2. Description of the Related Art

For electronic products providers, the common way to survive in the competitive market is to lower the product cost, reduce the product size, and improves the product quality. An inductor is a basic component in electronic products. Information, communication and consumers electronic products use a big amount of inductors. To fit the small-sized characteristic of electronic products, powder core type small size and low profile inductors for big current application are required.

FIG. 1 illustrates the structure of a conventional inductor. According to this prior art design, the inductor 90 is comprised of a powder compact member 91, an air coil 92, and two terminals 93 and 94. The coil 92 is embedded in the powder compact member 91. The two terminals 93 and 94 are respectively connected to the two opposite ends of the coil 92 and extended out of the powder compact member 91. During fabrication, the two terminals 93 and 94 are respectively connected to the two opposite ends of the coil 92, and then the coil 92 with the two terminals 93 and 94 are put in a mold, and a certain amount of magnetic powder material for powder compact member 91 is fed into the mold, and then the mold is compressed to compact the magnetic powder material and the coil 92, thereby forming the desired inductor 90.

After fabrication, the inductance value of the inductor is fixed, i.e., the inductance value of the inductor is not adjustable after fabrication. If the inductance value is not in conformity with the designed specification, the worker cannot adjust the inductance value of the inductor, and the inductor cannot be used. Therefore, the yield rate according to this inductor fabrication method is low.

The quality of the inductor made according to the aforesaid fabrication method is mainly determined subject to the quality of the magnetic powder material. Therefore, excellent magnetic powder material must be used for making high-quality inductors. However, using excellent magnetic powder material relatively increases the inductor's manufacturing cost, in consequence, lowers the supplier's competitive powder.

Further, after an inductor is made, a product specification and/or company's logo or trade name have to be printed on the surfaced of the inductor. Printing a product specification and/or company's logo or trade name on the surface of an inductor may cause deformation of the inductor.

### SUMMARY OF THE INVENTION

The present invention has been accomplished under the circumstances in view. It is one object of the present invention to provide a shielded-type inductor, which allows use of less expensive materials to lower the manufacturing cost without affecting the product quality. It is another object of the present invention to provide a shielded-type inductor, which is highly stable and reliable, and free from the interference of external environmental factors (temperature, moisture, etc.).

To achieve these and other objects of the present invention, the shielded-type inductor is comprised of a first powder compact member, a coil, and a second powder compact member. The first powder compact member has a bottom side and a top side. The coil comprises a coil body embedded in the bottom side of the first powder compact member in and two metal terminals respectively connected to the two opposite ends of the coil body and extending out of the first powder compact member. The second powder compact member is bonded to the bottom side of the first powder compact member and blocking the coil body in the bottom side of the first powder compact member.

Further, before bonding the second powder compact member to the first powder compact member, the second powder compact member can be printed or embossed with the product specification and/or company's logo or trade name. By means of controlling the thickness of the second powder compact member, the inductance value of the inductor is fine-adjusted. Further, the second powder compact member can be prepared from a relatively less expensive magnetic metal material to lower the cost without changing the designed electric characteristics.

Further, the first powder compact member and the second powder compact member are respectively prepared from a thermosetting resin mixture containing metal grains. The metal grains are coated with a layer of phosphoric acid (H₃PO₄) that protects the inductor against moisture attack. Further, the electrically insulative thermosetting resin used for the first powder compact member and the second powder compact member has strong toughness when hardened, thereby well protecting the inductor against the interference of external environmental factors (such as temperature, humidity, etc). Therefore, a shielded-type inductor made according to the present invention is high stable and reliable.

### BRIEF DESCRIPTION OF THE DRAWINGS

FIG. 1 is a sectional view showing the internal structure of an inductor according to the prior art.

FIG. 2 is a sectional view of the present invention, showing the second powder compact member bonded to the coil body-embedded bottom side of the first powder compact member.

FIG. 3 is an exploded view in section of the present invention, showing the second powder compact member separated from the coil body-embedded bottom side of the first powder member.

FIG. 4 is a schematic plain view showing a circular coil for shielded-type inductor according to the present invention.

FIG. 5 is a schematic plain view showing a rectangular coil for shielded-type inductor according to the present invention.

FIG. 6 is a sectional view of a first mold for the fabrication of a shielded-type inductor according to the present invention.

FIG. 7 is a sectional view of a second mold for the fabrication of a shielded-type inductor according to the present invention.

FIG. 8 is a shielded-type inductor fabrication flow according to the present invention.

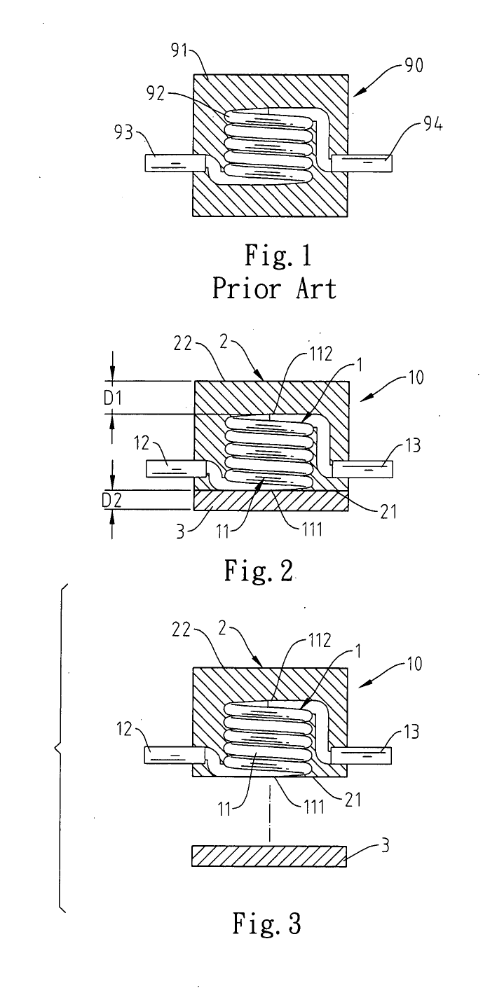

### DETAILED DESCRIPTION OF THE PREFERRED EMBODIMENT

Referring to FIGS. 2 and 3, a shielded-type inductor 10 in accordance with the present invention is shown comprised of a coil 1, a first powder compact member 2, and a second powder compact member 3.

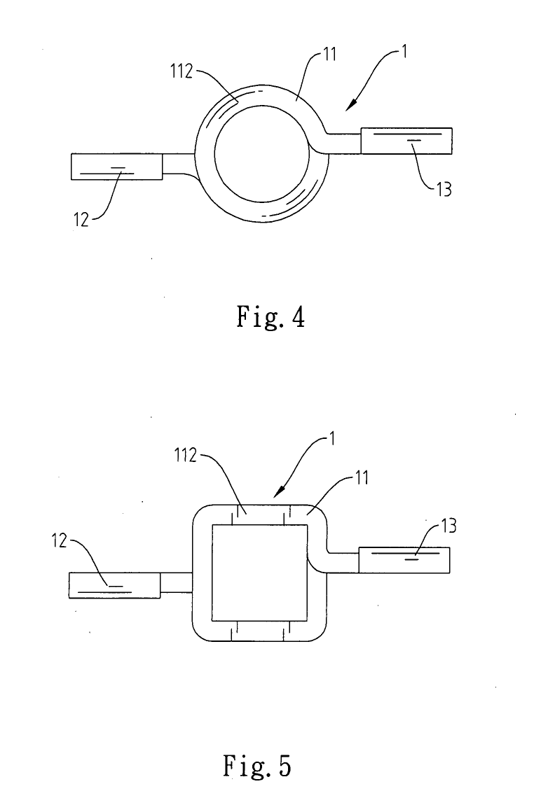

Referring to FIGS. 2 and 3 again, the coil 1 comprises a coil body 11, and two terminals 12 and 13 respectively connected to the two opposite ends of the coil body 11. The coil body 11 has a bottom side 111 and a top side 112. The coil body 11 is made out of a wire conductor (such as enameled wire) by means of a standard winding process on a center shaft. The coil body 11 can be formed by means of circular winding technique or rectangular winding technique. When circular winding technique is employed, the coil body 11 thus obtained shows the configuration of a circular multi-layer air coil (see FIG. 4). When rectangular winding technique is employed, the coil body 11 thus obtained shows the configuration of a rectangular multi-layer air coil (see FIG. 5). When compared to circular winding technique, the coil body 11 obtained from rectangular winding technique has an extra coil core cross-section about 27.39%. Therefore, the coil body 11 obtained from rectangular winding technique has a relatively higher inductance value and saturated current. The two terminals 12 and 13 are respectively connected to the two opposite ends of the coil body 11. Preferably, the two terminals 12 and 13 are formed of a wire conductor (for example, copper wire) and coated with two layers of electrically conductive metal coatings (for example, one layer of nickel coating and one layer of tin coating). The two terminals 12 and 13 may be respectively fastened to the two opposite ends of the coil body 11 by means of crimping or welding technique.

Referring to FIGS. 2 and 3 again, the first powder compact member 2 surrounds the coil body 11, i.e., the coil body 11 is embedded in the first powder compact member 2. The first powder compact member 2 is comprised of magnetic metal grains, a protective material, and an electrically insulative thermosetting resin (see FIG. 2). The magnetic metal grains are coated with a layer of the protective material. The protective material-coated magnetic metal grains are mixed with the electrically insulative thermosetting resin. The magnetic metal grains can be prepared from one single metal material, or multiple different metal materials. The protective material is phosphoric acid (H₃PO₄). Further, the first powder compact member 2 has a bottom side 21, and a top side 22. The coil body 11 is embedded in the first powder compact member 2 such that the bottom side 111 of the coil body 11 is kept in flush with the bottom side 21 of the first powder compact member 2, and the top side 22 of the first powder compact member 2 is spaced above the top side 112 of the coil body 11 at a distance D1.

Referring to FIGS. 2 and 3 again, the second powder compact member 3 is fastened to the bottom side 21 of the first powder compact member 3. Similarly, the second powder compact member 3 is comprised of magnetic metal grains, a protective material, and an electrically insulative thermosetting resin. The magnetic metal grains are coated, with a layer of the protective material. The protective material-coated magnetic metal grains are mixed with the electrically insulative thermosetting resin. The magnetic metal grains can be prepared from one single metal or metal alloy material, or multiple different metal materials or their compound. The protective layer is phosphoric acid (H₃PO₄). Further, it is allowable to change the initial magnetic permeability (Ui value) subject to the composition of the magnetic metal grains, thereby fine-adjusting the inductance value of the finished product. If the composition of the magnetic metal grains remains unchanged, changing the thickness D1 of the second powder compact member 3 (see FIG. 2) can fine-adjust the inductance value of the finished product.

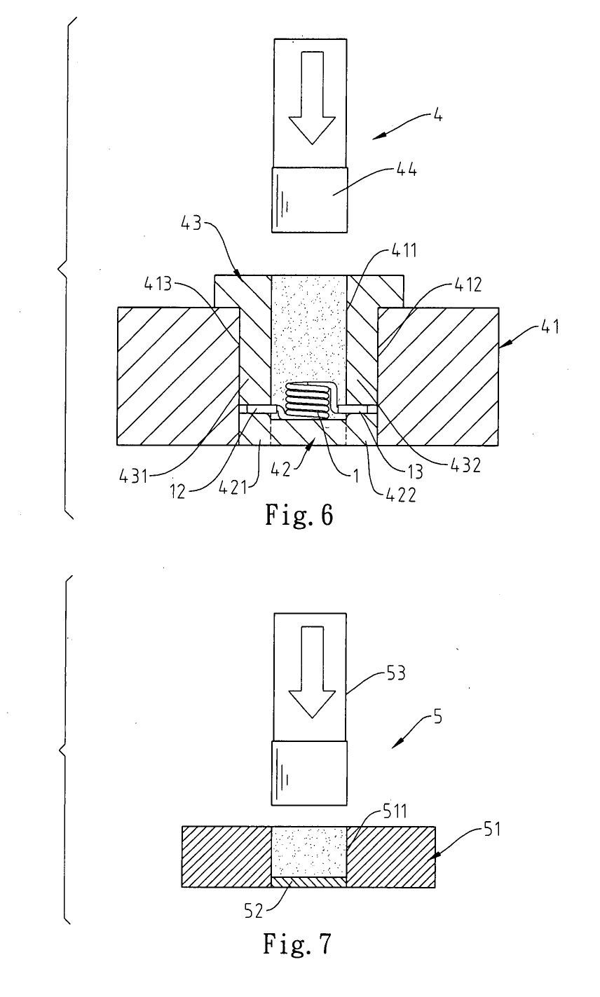

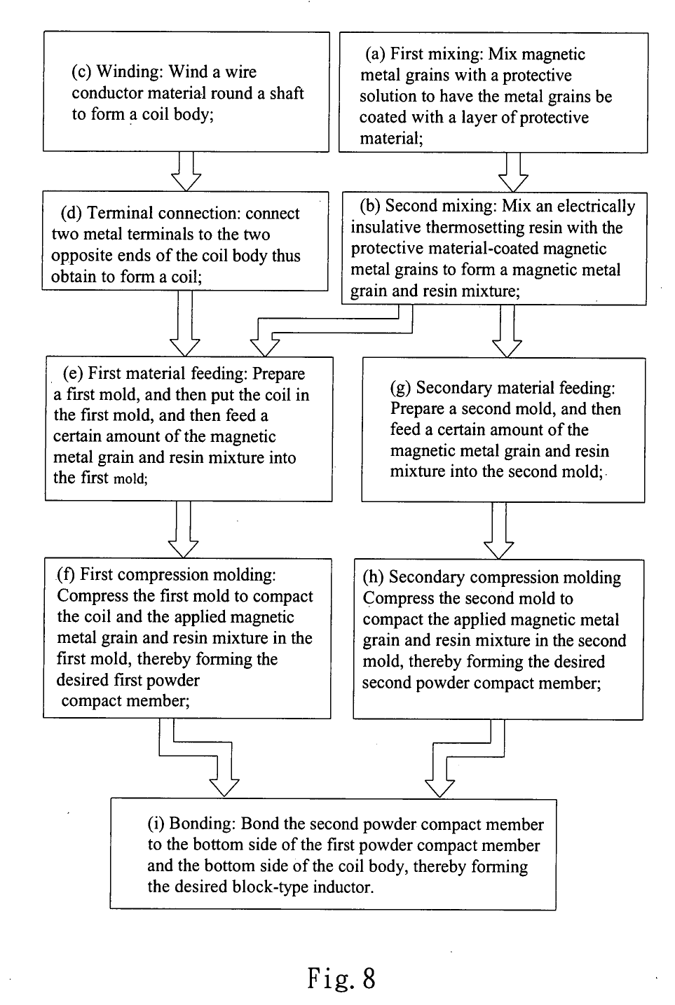

The fabrication of the shielded-type inductor 10 is outlined hereinafter with reference to FIGS. 2 through 8. As stated, the shielded-type inductor 10 is comprised of a coil 1, a first powder compact member 2, and a second powder compact member 3. Further, the shielded-type inductor 10 is made by means of the application of a first mold 4 and a second mold 5. As shown in FIGS. 6 and 7, the first mold 4 is comprised of a female die 41, a bottom die 41, a locating block 43, and a top die 44. The female die 41 has a die cavity 411, and two receiving cavities 412 and 413 at two opposite sides relative to the die cavity 411. The die cavity 411 is adapted to mold the first powder compact member 2. The two receiving cavities 412 and 413 are adapted to receive the two terminals 12 and 13. The bottom die 42 has two bearing portions 421 and 422 respectively fitted into the two receiving cavities 412 and 413 at the bottom side. The locating block 43 is movably mounted in the die cavity 411 at the top. The locating block 43 has two positioning portions 431 and 432 respectively inserted into the two receiving cavities 412 and 413 at the top and spaced above the two bearing portions 421 and 422 of the bottom die 42 a respective gap for accommodating the two terminals 12 and 13. The top die 44 is linearly movable (vertically movable) in the die cavity 411 of the bottom die 41. The second mold 5 is comprised of a female die 51, a bottom die 52, and a top die 53. The female die 51 has a die cavity 511 for molding the second powder compact member 3. The bottom die 52 is movably mounted in the bottom side of the die cavity 511. The top die 53 is linearly movable (vertically movable) in the die cavity 511.

The fabrication procedure includes the steps of:

(a) first mixing, where magnetic metal grains are mixed with a protective solution to have the metal grains be coated with a layer of protective material;

(b) second mixing, wherein an electrically insulative thermosetting resin is mixed with the protective material-coated magnetic metal grains to form a magnetic metal grain and resin mixture;

(c) winding, wherein a wire conductor material is wound round a shaft to form a coil body;

(d) terminal connection, where two metal terminals are respectively connected to the two opposite ends of the coil body thus obtain, forming a coil;

(e) first material feeding, where a first mold is prepared, the coil thus obtained from step (d) is put in the first mold, and then a certain amount of the magnetic metal grain and resin mixture thus obtained from step (b) is fed into the first mold;

(f) first compression molding, wherein the first mold is compressed to compact the coil and the applied magnetic metal grain and resin mixture in the first mold, forming the desired first powder compact member;

(g) secondary material feeding, where a second mold is prepared, and then a certain amount of the magnetic metal grain and resin mixture thus obtained from step (b) is fed into the second mold;

(h) secondary compression molding, wherein the second mold is compressed to compact the applied magnetic metal grain and resin mixture in the second mold, forming the desired second powder compact member;

(i) bonding, where the second powder compact member thus obtained from step (f) is bonded to the bottom side of the first powder compact member and the bottom side of the coil body thus obtained from step (h), thereby forming the desired shielded-type inductor 10.

Although particular embodiments of the invention have been described in detail for purposes of illustration, various modifications and enhancements may be made without departing from the spirit and scope of the invention.

What the invention claimed is:

1. A shielded-type inductor comprising
a first powder compact member, said first powder compact member having a bottom side and a top side;
a coil embedded in said first powder compact member, said coil comprising a coil body embedded in the bottom side of said first powder compact member and two metal terminals respectively connected to two opposite ends of said coil body and extending out of said first powder compact member; and
a second powder compact member bonded to the bottom side of said first powder compact member and blocking said coil body in the bottom side of said first powder compact member.

2. The shielded-type inductor as claimed in claim 1, wherein said coil body is a circular multi-layer air coil.

3. The shielded-type inductor as claimed in claim 1, wherein said coil body is a rectangular multi-layer air coil.

4. The shielded-type inductor as claimed in claim 1, wherein said coil body has a bottom side embedded in the bottom side of said first powder compact member and kept in flush with the bottom side of said first powder compact member, and a top side embedded in said first powder compact member and spaced between the top side and bottom side of said first powder compact member.
